(19) United States
(12) Patent Application Publication
(10) Pub. No.: US 2007/0041679 A1
(43) Pub. Date: Feb. 22, 2007

(54) Integrated thin film MSM photodetector/grating for WDM

(76) Inventor: Zhaoran Huang, Watervliet, NY (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/480,760

(22) Filed: Jul. 3, 2006

Related U.S. Application Data
(63) Continuation of application No. 11/479,127, filed on Jun. 30, 2006.
(60) Provisional application No. 60/696,478, filed on Jul. 1, 2005.

(51) Int. Cl. G02B 6/12

(52) U.S. Cl. 385/14; 385/37

(57) ABSTRACT

An integrated optical signal wavelength demultiplexing device, which may simultaneously demultiplex and detect an optical signal, is discussed. The integrated device features a waveguide structure to carry an optical signal, a photodetector in close proximity to the waveguide structure, and a wavelength limiting grating structure integrated with the photodetector and coupling the waveguide structure to the photodetector. The grating structure is fabricated within the photodetector and is used to transmit only a selected wavelength onto the photodetector.

### RELATED APPLICATION

This application is a continuation of U.S. Application filed on Jun. 30, 2006, attorney docket no. 3230.1008-001, entitled “Integrated Thin Film MSM Photodetector/Grating for WDM”, inventor Zhaoran Huang, which claims the benefit of U.S. Provisional Application No. 60/696,478, filed on Jul. 1, 2005. The entire teachings of the above application is incorporated herein by reference.

### BACKGROUND OF THE INVENTION

In optical communication systems, wavelength division multiplexing (WDM) is commonly used to transport information. Optical WDM is a technology where multiple sources of information are combined, resulting in a multi-channel signal, on a single optical fiber by using different wavelengths of laser light to carry the different signals. A demultiplexer is typically used at a receiver to separate the signal into its respective wavelengths. WDM systems allow for an expansion of the capacity of a network without increasing the amount of optical fiber utilized.

An optical communication system 100 is shown as FIG. 1. Various chips 1-4 are interconnected with the use of optical waveguides. The chips 0-4 all comprise photo-detection devices as well as wire bonding pads. Multi-channel signals are transmitted to the optical communication system via optical inputs 1 and 2. Optical waveguide splitters 101 are then used to branch off or distribute the optical signals to the various chips 1-4. Once a multi-channel signal reaches a photo-detection device 103, the photo-detection device 103 demultiplexes the multi-channel signal and detects the selected wavelength. The wire bonding pads 105 may be used to supply electronic power to the various chips 1-4.

A typical optical waveguide 200, as shown in FIG. 2, comprises three regions, an upper cladding 204, a core 205, and an under cladding 206. The main purpose of the optical waveguide is to guide light waves through the use of total internal reflection. In order for total internal reflection to occur, the core of the waveguide must have a higher refractive index than the upper and under claddings and the angle of incidence of the light beam must be at an angle less than a critical angle. Thus, the optical signal may travel through the core of the waveguide while reflecting from the top and bottom surfaces of the core. As is shown in FIG. 2, a multi-channel signal comprising various wavelengths, 201 and 203, may be transmitted through the core 205 of the waveguide by total internal reflection.

As was previously mentioned, in order to detect a signal of a particular wavelength from a multi-channel signal, the multi-channel signal may be demultiplexed. One method of demultiplexing involves the use of a diffraction grating. A diffraction grating 300, shown in FIG. 3, consists of multiple gratings or peaks 302. When a polychromatic light source impinges on a diffraction grating, each wavelength is diffracted at a different angle and therefore to a different point in space. As an incoming multi-channel signal 301 approaches the grating 300, the signal is reflected and separated into its respective wavelengths 303 and 305.

Upon demultiplexing, photo-detection may be performed. Many photo-detection devices may be used in the detection of the optical signal; as examples a p-i-n, avalanche or metal-semiconductor-metal (MSM) photodetector may be employed. An MSM photodetector is shown in FIGS. 4A and 4B. The MSM photodetector 400 comprises a metal contact superimposed on various semiconductor layers. The MSM photodetector semiconductor layers 408 comprise a cap layer 404, an absorbing layer 402, a buffer layer 405, and a thinned substrate layer 401. The MSM photodetector 400 also features MSM electrodes 406 which are interdigitated Schottky metal contacts on top of the MSM cap layer 404. Once the active or absorbing layer 402 is illuminated by an optical signal or light 407, electron-hole pairs or carriers 403 are generated within the layer. The carriers are transported to the contact pads 407 which are supplied with a voltage. The MSM photodetector detects photons by collecting electric signals generated by photo-excited electrons and holes in the semiconductor 408 that drift to respective interdigitated fingers under the electrical field applied between the interdigitated fingers 406.

Detailed examples of a photo-detection device, as shown in FIG. 1, are displayed in FIGS. 5A and 5B. The photo-detection device of FIG. 5A comprises an optical polymer waveguide 501 superimposed over an MSM photodetector 400. As was discussed above, the MSM photodetector 400 comprises a thinned substrate 401, a cap layer 404, an absorbing layer 402, a buffer layer 405, and electrodes 406. The polymeric waveguide 501 comprises an upper cladding 502, a core 504, and an under cladding 505. The upper cladding 502 further comprises a diffraction grating 503. As was discussed above in relation to FIG. 3, the diffraction grating is used to demultiplex the multi-channel signal traveling in the core of the optical polymer waveguide. The grating is designed such that only light of one particular wavelength (in the example provided by FIG. 5A, λ₁) will be selected at angle such that the signal of that wavelength will be reflected into the MSM photodetector 400.

The photo-detection device of FIG. 5B works in a manner similar to that of the device shown in FIG. 5A. The photo-detection device of FIG. 5B comprises a polymeric waveguide 506 and an MSM photo-detector 400, similar to the MSM photodetector of FIG. 5A. The polymeric waveguide comprises an upper cladding 507, a core 508, and an under cladding 509. The most striking difference between the photo-detection devices featured in FIGS. 5A and 5B is that the diffraction grating featured in waveguide 506 is fabricated within the core 508 of the waveguide instead of the upper cladding 507. Both the gratings in FIGS. 5A and 5B, may be used to reflect light of a selected waveguide into the MSM photodetector 400.

### SUMMARY OF THE INVENTION

An integrated optical signal wavelength demultiplexing device and method is discussed. The device comprises a waveguide structure to carry an optical signal, a photodetector in close proximity to the waveguide structure, and a wavelength limiting grating structure integrated with the photodetector and coupling the waveguide structure to the photodetector. The photodetector may be in the form of a metal-semiconductor-metal (MSM) photodetector, the MSM photodetector may further comprise a cap layer, an absorbing layer, a buffer layer and a substrate, wherein all these layers may be formed in semiconductor material with a grating structure formed in a side of the MSM photodetector opposite of the electrodes. The MSM photodetector may also be backside illuminated.

The waveguide structure may comprise a top cladding, an optical signal carrier core, and an under-cladding layer. The waveguide structure may also be formed in a material comprising a lower index of refraction than the photodetector and the grating structure, for example polymer. The grating structure may be filled with material of the waveguide. The optical signal may be evanescently coupled from the waveguide to the photodetector.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic of an optical communication system;

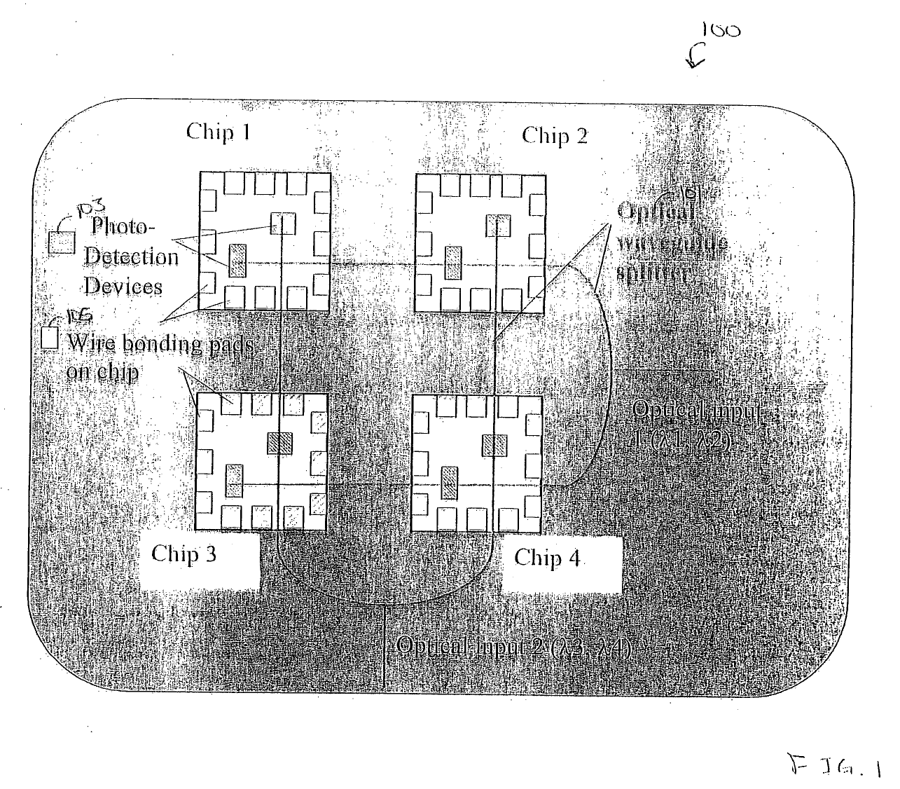

FIG. 2 is a diagram for a multi-channel signal traveling through an optical waveguide;

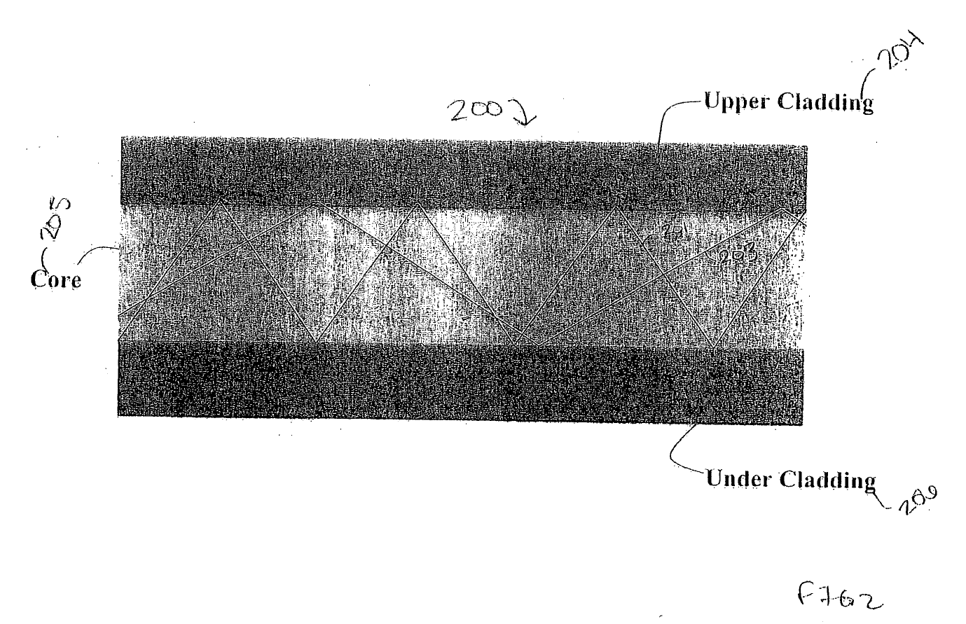

FIG. 3 is a schematic of an illustrated example of the use of a diffraction grating;

FIGS. 4A and 4B are a top and cross-sectional view, respectively, of an MSM photodetector;

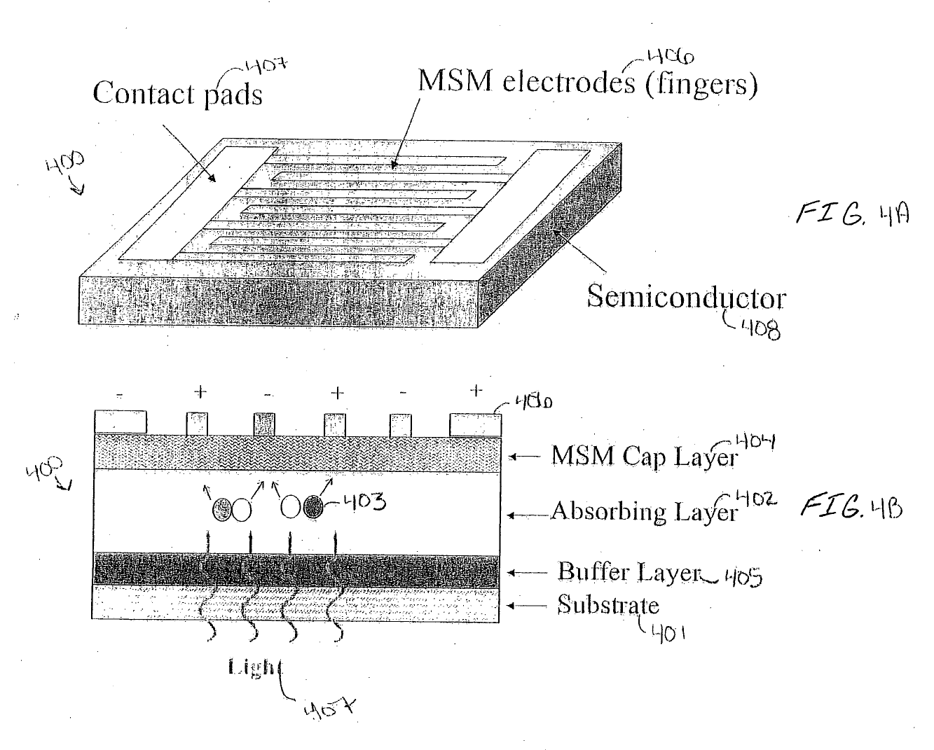

FIGS. 5A and 5B are schematics of photo-detection devices according to the prior art.

FIGS. 6A and 6B are cross section views of a photo-detection device according to an embodiment of the present invention.

### DETAILED DESCRIPTION OF THE INVENTION

A description of preferred embodiments of the invention follows.

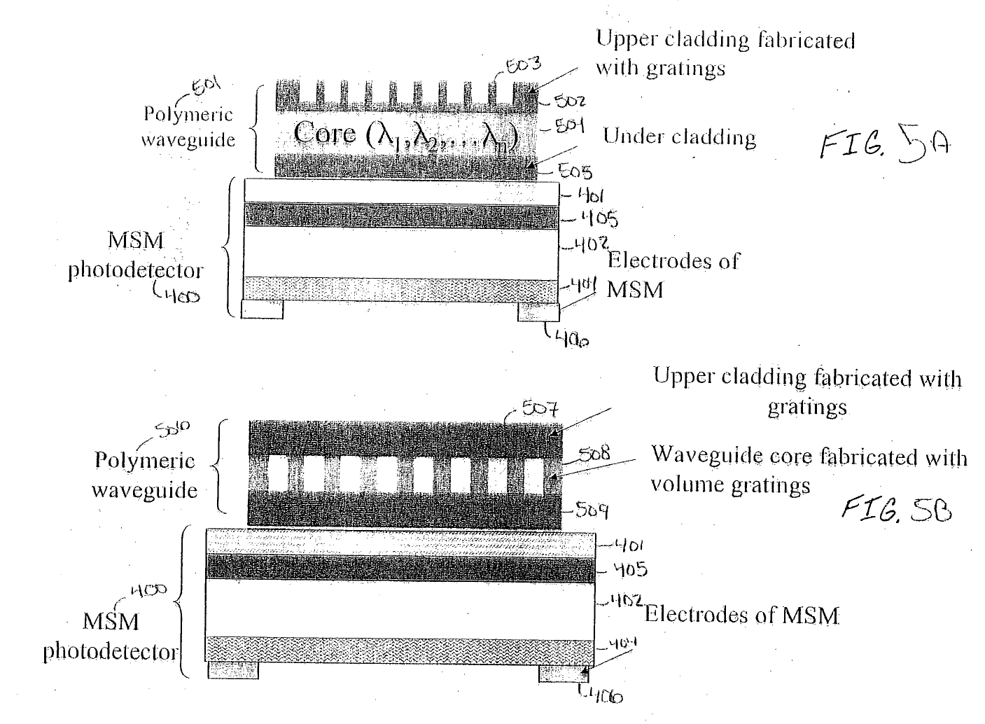

Many problems may arise when fabricating a diffraction grating from a polymer substance such as the polymeric waveguides of FIGS. 5A and 5B. In particular, long term reliability is often an issue for polymer based optical devices. Since the molecular arrangement of a polymeric material is not very solid, over time the grating may deform.

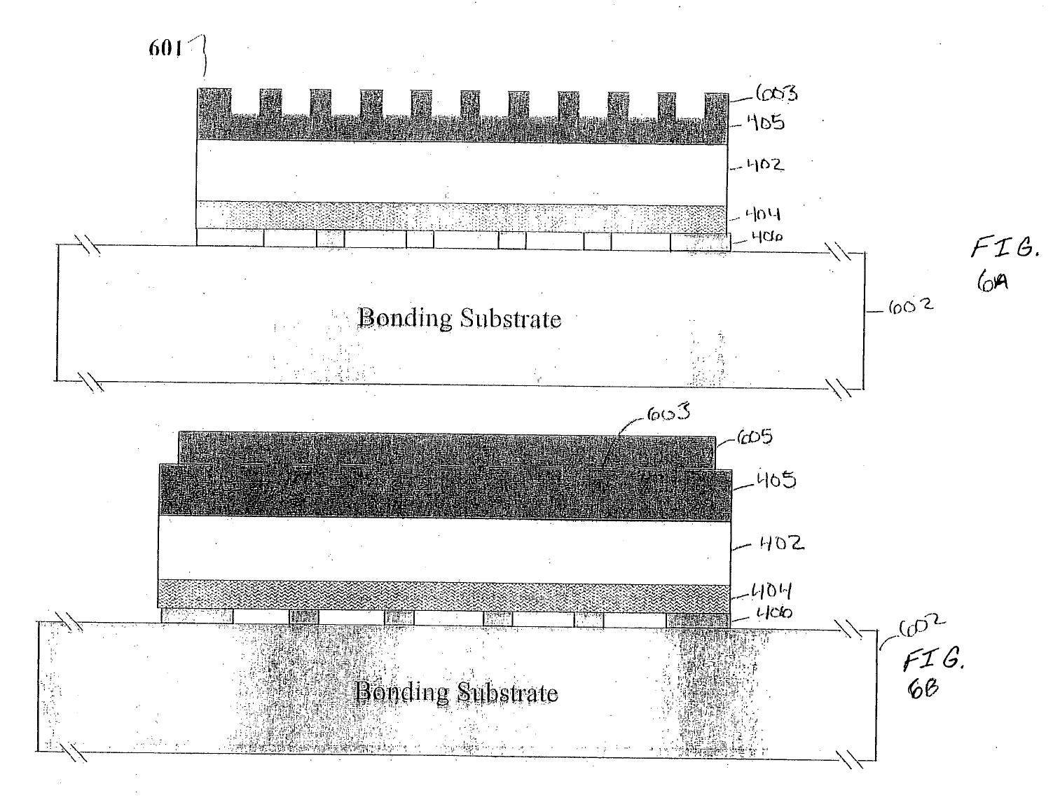

A high-speed demultiplexing and detection embodiment of the present invention is shown in FIG. 6A. FIG. 6A displays an MSM photodetector 400 mounted on a substrate 602. The MSM photodetector 400 comprises a cap layer 404, an absorbing layer 402, a buffer layer 405, and electrodes 406. It should be appreciated that the MSM photodetector 400 may include a thinned substrate layer above the buffer layer 405. The MSM photodetector 400 is arranged in a manner to allow for backside illumination. In backside illumination, an optical signal is directed to the absorbing layer 402 through the buffer layer 405, or alternatively the thinned substrate layer 401; while in frontside illumination, the signal is directed to the absorbing layer 402 through the electrodes 406 and cap layer 404.

When employing frontside illumination, a problem of finger shadowing commonly occurs. Since the electrode fingers 406 are not transparent, during frontside illumination a portion of the optical signal may be reflected off of the fingers 406, thus causing loss which is also known as finger shadowing. Backside illumination prevents finger shadowing and thereby also reduces the amount of loss suffered by the incoming optical signal. The buffer layer 405 does not absorb the incoming signal but instead reduces defect density between the substrate and the absorbing layer, thus reducing leakage current and increasing response speed.

The buffer layer 405, shown in FIGS. 6A and 6B, comprises an MSM grating 603. Unlike the diffraction gratings shown in FIGS. 5A and 5B, the MSM grating 603 is fabricated completely out of a semiconductor material (i.e. the MSM buffer layer 405). Thus, the issue of long term reliability is no longer a problem as the molecular arrangement of a semiconductor material is much more solid and durable than that of a polymer. Furthermore, as seen in FIG. 6B, the optical polymer waveguide 605 is superimposed on the buffer layer 405 of the MSM photodetector 400. Thus, the MSM grating 603 is further protected by being embedded in the material of the waveguide 605. It should be appreciated that a semiconductor waveguide may be used. In that case, the grating gaps may be filled with waveguide semiconductor or left open.

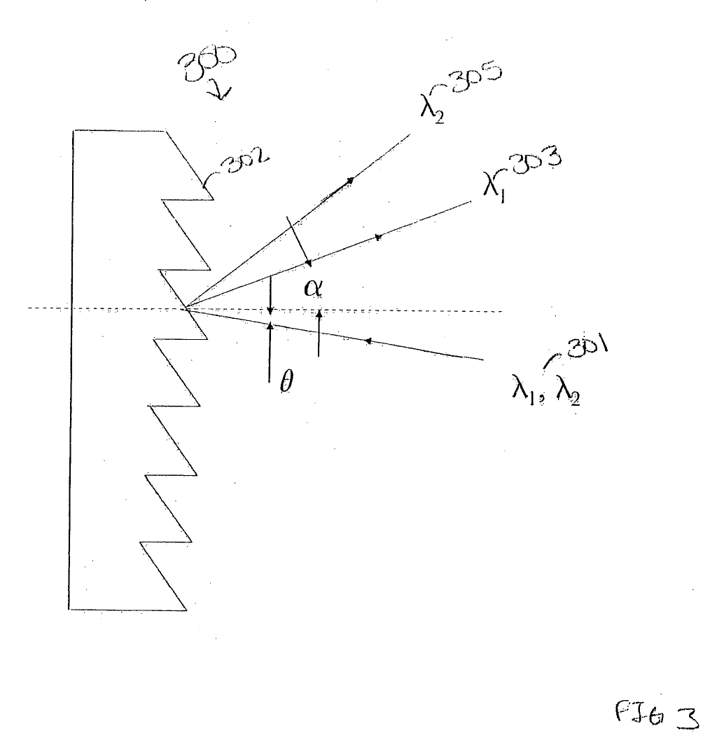

The MSM grating 603 shown in FIGS. 6A and 6B does not function in the same manner as the diffraction gratings shown in FIGS. 3, 5A and 5B. As explained above, diffraction gratings reflect and separate a multi-channel signal into various waveguide components at different angles. An MSM grating instead transmits a single wavelength in to the absorption layer 402 of the MSM photodetector 400. Therefore, as the multi-channel signal travels through the optical waveguide 605, the selected wavelength is evanescently coupled into the active region 402 of the MSM photodetector 400. Wavelength selection may be determined by the spacing of the grating peaks 601.

The photo-detection device of FIGS. 6A and 6B also allows for simultaneous demultiplexing and detection of an optical signal. Thus, with use of the device featured in FIGS. 6A and 6B, it is possible to increase the speed of optical communication networks by combining the steps of demultiplexing and detection into a single step. The fabrication of the MSM grating 603 in the semiconductor material may also be easily obtained compared to the fabrication of the diffraction grating in the polymer waveguide.

Furthermore, the semiconductor material generally has a refractive index above n=3, for example, n=3.2 for Si, n=3.5 for InP, and n=3.65 for InGaAs; whereas, the refractive index of polymeric material is in the range of n=1.4˜1.8. Therefore, a high contrast of refractive index is obtained at the interface of the grating structure with the polymeric waveguide. The high index difference at the grating structure 603 is desirable for easily creating a long period grating pitch, or ensuring that the grating period is larger than the wavelength of the selected wavelength. A high extraction ratio, or the amount of the optical signal which may be coupled, may also be obtained with a high contrast of refractive index.

Although the gratings have been shown in the buffer layer 405 of the MSM detector 400, it should be appreciated that other alterations may be possible. For example; the grating structure 603 may be fabricated in the thinned substrate 401, the grating structure may be fabricated within the thinned substrate 401 and the buffer layer 405, the thinned substrate layer and the buffer layer may be removed from the MSM photodetector with the grating structure fabricated directly in the absorbing layer 402, or the grating structure may be fabricated in the buffer and absorbing layers, with the thinned substrate layer being removed.

While this invention has been particularly shown and described with references to preferred embodiments thereof, it will be understood by those skilled in the art that various changes in form and details may be made therein without departing from the scope of the invention encompassed by the appended claims. For example it should be appreciated that other means of photo-detection may be employed, for example pin or avalanche photodetectors.

What is claimed is:

1. An integrated optical signal wavelength demultiplexing device comprising:
a waveguide structure to carry an optical signal;
a photodetector in close proximity to the waveguide structure; and
a wavelength limiting grating structure integrated with the photodetector and coupling the waveguide structure to the photodetector.

2. The device of claim 1, wherein the photodetector is a metal-semiconductor-metal (MSM) photodetector, the MSM photodetector comprising electrodes on a side.

3. The device of claim 2, wherein the MSM photodetector is backside illuminated.

4. The device of claim 2, wherein the grating structure is formed in a side opposite of the electrodes of the MSM photodetector.

5. The device of claim 4, wherein the grating structure is formed of semiconductor material.

6. The device of claim 5, wherein the waveguide structure is formed of a material comprising a lower index of refraction than the photodetector and the grating structure.

7. The device of claim 6, wherein the waveguide structure is a polymer.

8. The device of claim 6, wherein the grating structure is filled with material of the waveguide.

9. The device of claim 1, wherein the optical signal is evanescently coupled from the waveguide to the photodetector.

10. A method of demultiplexing and detecting an optical signal comprising:
carrying an optical signal in a waveguide structure; and
interconnecting the waveguide structure to a photodetector with a wavelength limiting grating structure integrated with the photodetector.

11. The method of claim 10, wherein the photodetector is a metal-semiconductor-metal (MSM) photodetector, the MSM photodetector comprising electrodes on a side of the MSM photodetector.

12. The method of claim 11 further comprising:
illuminating the MSM photodetector through a backside.

13. The method of claim 1 1, wherein the grating structure is formed in a side opposite of the electrodes of the photodetector.

14. The method of claim 13, wherein the grating structure is formed of semiconductor material.

15. The method of claim 14, wherein the waveguide structure is formed of a material comprising a lower index of refraction than the photodetector and the grating structure.

16. The method of claim 15, wherein the waveguide structure is polymer.

17. The method of claim 16, wherein the grating structure is filled with material of the waveguide.

18. The method of claim 10, further comprising:
evanescently coupling the optical signal from the waveguide structure to the photodetector.

19. The method of claim 18, further comprising:
simultaneously providing wavelength demultiplexing, with use of the grating structure, and high speed optical detection, with use of the photodetector.

20. An integrated optical signal wavelength demultiplexing device comprising:
a transport means for carrying an optical signal;
a detecting means for detecting the optical signal; and
a waveguide selection means for performing waveguide selection, the waveguide selection means coupling the transport means and the detecting means.
